(19) United States
(12) Patent Application Publication
(10) Pub. No.: US 2014/0183238 A1
(43) Pub. Date: Jul. 3, 2014

(54) PORTABLE ELECTRONIC DEVICE HOLDER FOR CAR

(71) Applicant: Rocky Yi-Ping Lin, Taipei City (TW)

(72) Inventor: Rocky Yi-Ping Lin, Taipei City (TW)

(21) Appl. No.: 13/731,033

(22) Filed: Dec. 30, 2012

(51) Int. Cl. B60R 7/00

(52) U.S. Cl. CPC B60R 7/00
USPC 224/483

(57) ABSTRACT

A portable electronic device holder for car includes a fixation base, a clamping base, and a rotating structure provided therebetween. The fixation base includes a cover and a bottom board connected with height adjusting screw pieces. A sliding plate is provided between the bottom board and the cover, and the sliding plate slides on the bottom board without detaching. The clamping base includes a supporting plate and retractable plates, and the retractable plates can slide in a direction parallel to the supporting plate. The retractable plate is provided with clamping wings, and the clamping wings can move in a direction horizontal to the supporting plate. The rotating structure connects the sliding plate and the supporting plate, and the clamping base rotates relative to the fixation base via the rotating structure. By this arrangement, the position and angle of the holder can be adjusted for holding the portable electronic device.

### BACKGROUND

1. Technical Field

The present application relates to a portable electronic device holder, particularly to a portable electronic device holder used in a car.

2. Related Art

By the maturation and popularization of the internet and satellite technology, the portable electronic device such as satellite navigator, mobile phone, or personal digital assistant, etc. can already provide convenient functions of communication, entertainment, internet connection, and position tracking, etc. to perfect the function of the portable electronic devices.

Nowadays, the portable electronic device has more and more functions, which makes people more rely on electronic devices. Those electronic devices, such as satellite navigation device used on driving, are very convenient tools for all the people. Therefore, most of the people usually use fixation rack to fix the portable electronic device in the car to adjust the angle or position of the portable electronic device.

The conventional fixation rack used in car has a clamper and a positioning element. The clamper is used to clamp and fix the portable electronic device. The positioning element has a rod and a sucking disk. The rod is used to connect the clamper, and the sucking disk adheres to the windshield or near the dashboard of the car. However, the conventional fixation rack has some drawbacks when in use. After being placed on the fixation rack, the portable electronic device often falls off from the fixation rack due to the shaking of the car. Moreover, the rod of the fixation rack is easy to be bent and deformed due to the weight of the portable electronic device, thus causing unable to change the position and the angle as demand.

### BRIEF SUMMARY

The present application provides a portable electronic device holder for car to firmly hold and position the portable electronic device.

The present application also provides a portable electronic device holder for car, which allows the user to adjust the holder to the position and angle as demand, thereby facilitating the user to use the portable electronic device.

The present application relates to a portable electronic device holder for car, which comprises a fixation base, a clamping base, and a rotating structure. The fixation base includes a bottom board and a cover covering thereof, a bottom of the bottom board connected with a pair of height adjusting screw pieces, a sliding plate provided between the bottom board and the cover, a bottom of the sliding plate provided with a sliding rail, a sliding groove provided on the bottom board corresponding to the sliding rail, the sliding rail sliding in the sliding groove for securing the sliding plate to slide on the bottom board without detaching; a clamping base provided on one side of the fixation base, the clamping base comprising a supporting plate and two retractable plates connected to two opposite sides of the supporting plate, the two retractable plates moving in a direction parallel to the supporting plate, each of the two retractable plates provided with two clamping wings, the two clamping wings moving in a direction horizontal to the supporting plate; a rotating structure provided between the fixation base and the clamping base and connecting to the sliding plate and the supporting plate, the clamping base rotating relative to the fixation base via the rotating structure.

The present application also provides a portable electronic device holder for car, where an arc shape clamping surface is formed at the end of the clamping wing to firmly clamp the portable electronic device.

Compared to the conventional technique, the holder according to the present application provides a rotating structure between the fixation base and the clamping base. The clamping base can rotate relative to the fixation base via the rotating structure, and the conventional rod structure can be waived accordingly. Besides, the fixation base according to the present application is provided with a sliding plate, which allows the clamping base to be adjusted the forward or backward distance to firmly hold the portable electronic device. The holder of the present application also allows the user to adjust the position and angle of the holder for facilitating the user to use the portable electronic device, thereby increasing the practicability of the present application.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an exterior schematic diagram of a holder according to the present application;

FIG. 2 is a first exploded perspective view of the holder according to the present application;

FIG. 3 is a second exploded perspective view of the holder according to the present application;

FIG. 4 is a schematic view showing combination of a fixation base and a rotating structure according to the present application;

FIG. 5 is a sectional view of the combination of the fixation base and the rotating structure according to the present application;

FIG. 6 is a schematic view showing the sliding of the sliding plate according to the present application;

FIG. 7 is an exploded perspective view of a clamping base according to the present application;

FIG. 8 is a planar schematic view of the assembled clamping base according to the present application;

FIG. 9 is a perspective schematic view of the assembled clamping base according to the present application;

FIG. 10 is an operation schematic view of the holder according to the present application; and

FIG. 11 is a disassembled schematic view of the holder according to the present application.

### DETAILED DESCRIPTION

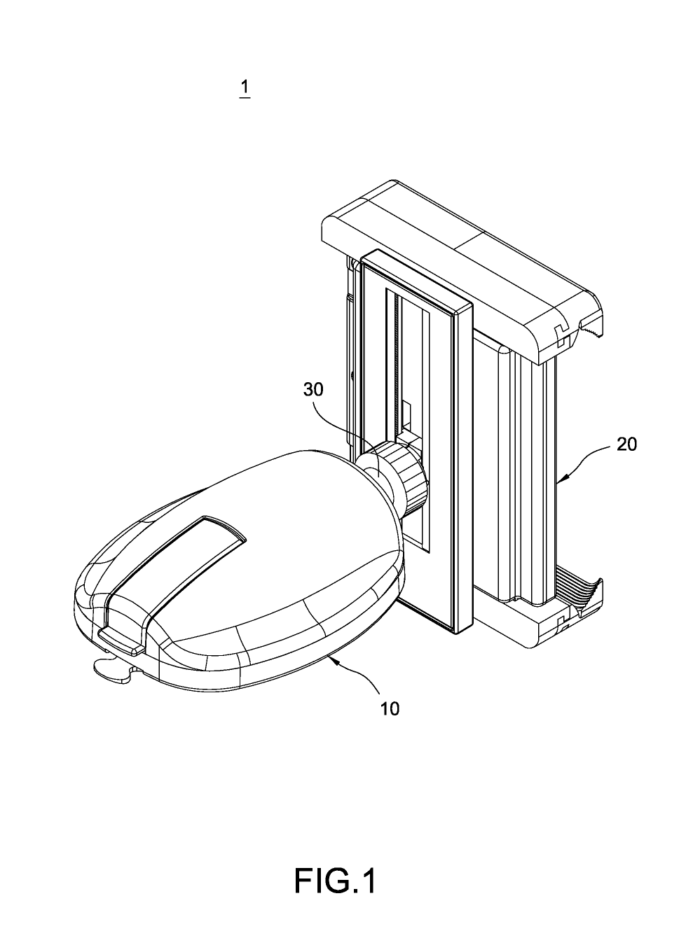

Please refer to FIG. 1. A portable electronic device holder 1 for car according to the present application includes a fixation base 10, a clamping base 20, and a rotating structure 30. The rotating structure 30 connects to the fixation base 10 and the clamping base 20, and the clamping base 20 can rotate relative to the fixation base 10 via the rotating structure 30.

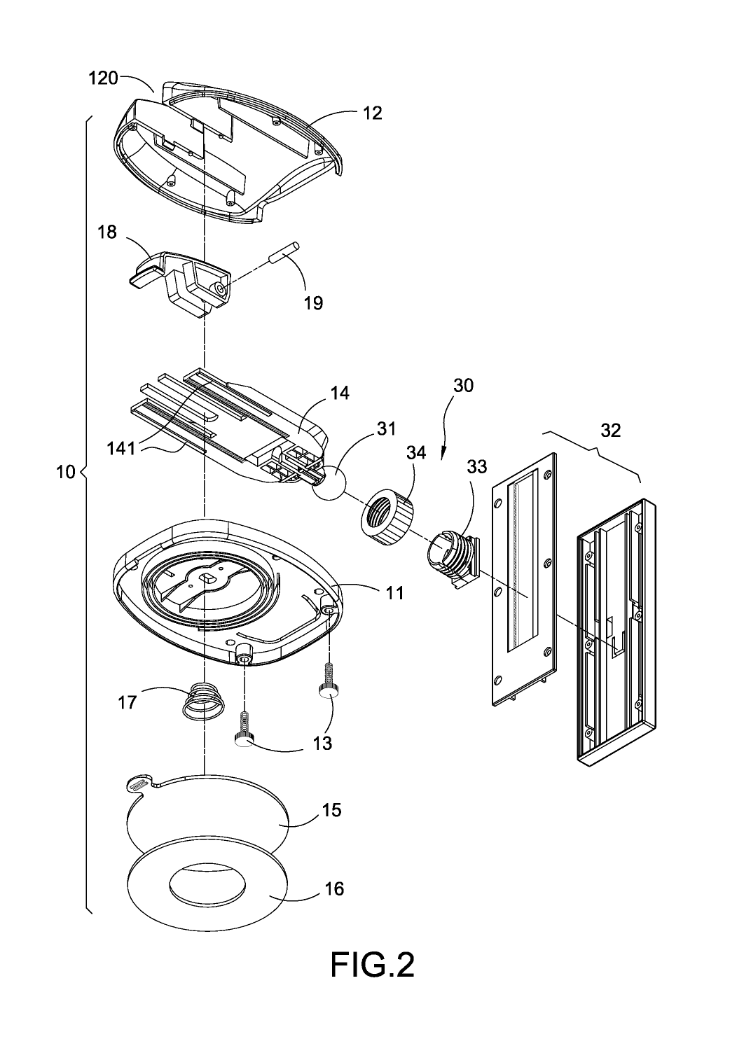

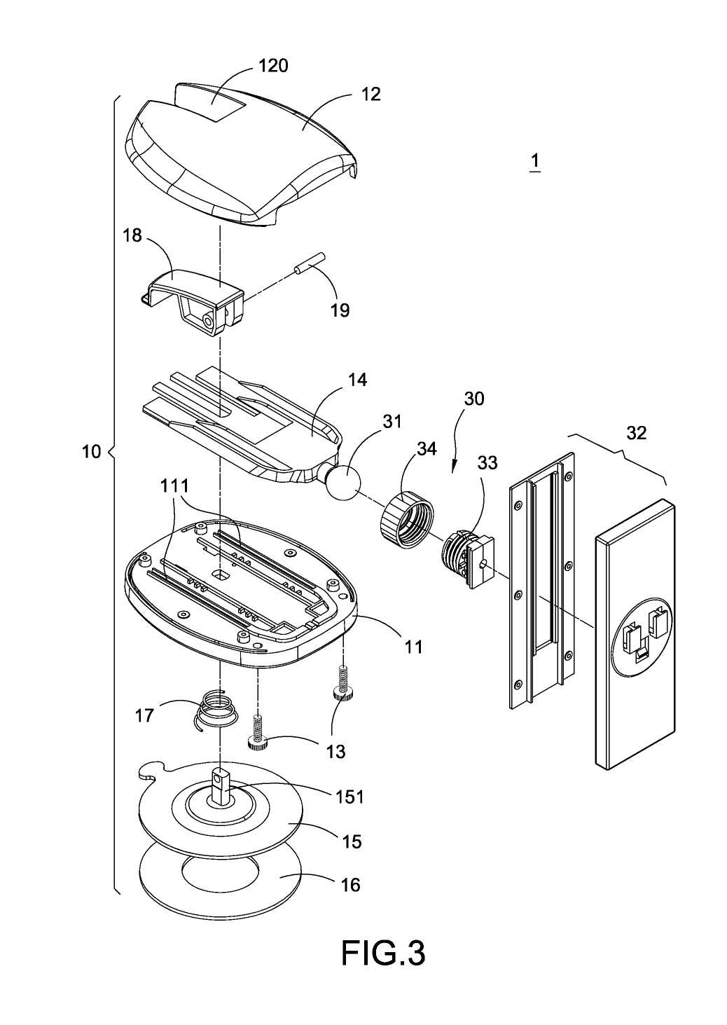

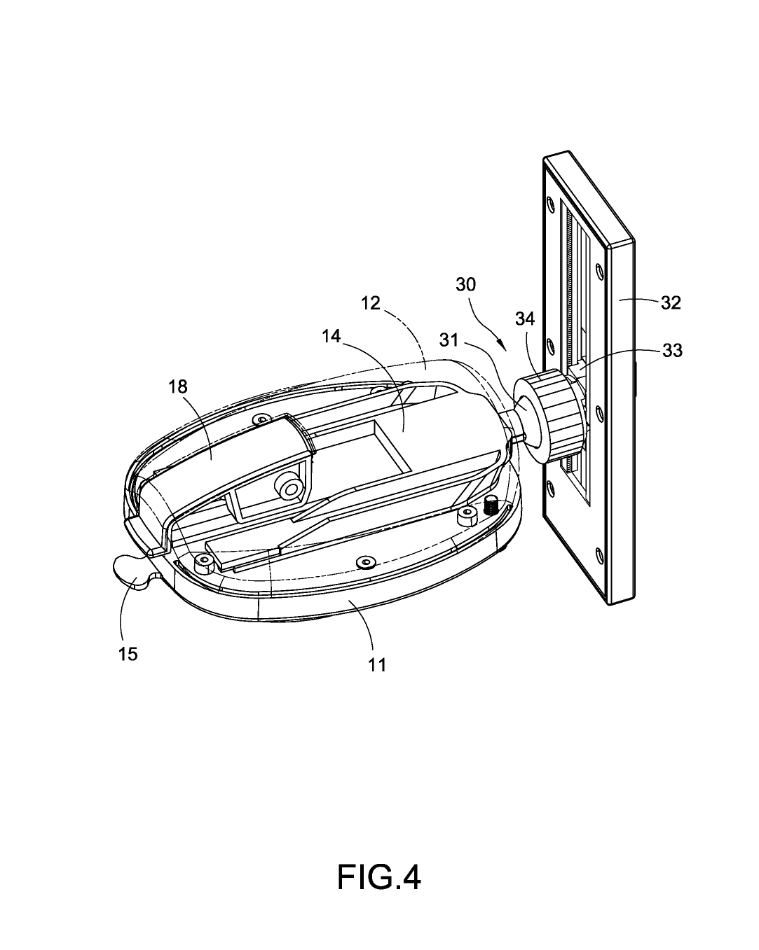

Please also refer to FIGS. 2 to 4. The fixation base 10 includes a bottom board 11 and a cover 12 covering thereof. A bottom of the bottom board 11 is connected with a pair of height adjusting screw pieces 13, and a sliding plate 14 is provided between the bottom board 11 and the cover 12. A bottom of the sliding plate 14 is provided with a sliding rail 141, and a sliding groove 111 for the sliding rail 141 sliding therein is provided on the bottom board 11 corresponding to the sliding rail 141.

In one embodiment of the present application, the fixation base 10 further includes a sucking disk 15, a rubber ring 16, and a spring 17. The sucking disk 15 connects to the bottom of the bottom board 11. One side of the rubber ring 16 adheres to a bottom of the sucking disk 15, and the other side of the rubber ring 16 adheres to a car body, such as dashboard or windshield, etc. The spring 17 is elastically sandwiched between the bottom board 11 and the sucking disk 15 to provide the elastic force to the sucking disk 15.

Besides, the fixation 10 further includes a pulling rod 18 and a bolt 19. One side of the sucking disk 15 facing to the bottom board 11 is provided with an axle 151, and the pulling rod 18 connects to the axle 151 via the bolt 19 to pivotally connect to the fixation base 10. Preferably, the cover 12 is provided with an accommodating trough 120 corresponding to a position of the pulling rod 18 to connect the pulling rod 18 in the accommodating trough 120.

In the present embodiment, the bottom board 11 is provided with a through hole 110 corresponding to a position of the axle 151, and the axle 151 passes through the through hole 110 and the sliding plate 14 to connect the bolt 19.

The rotating structure 30 is provided between the fixation base 10 and the clamping base 20, and the clamping base 20 can rotate relative to the fixation base 10 via the rotating structure 30. The rotating structure 30 includes a ball shaft 31 connecting to one end of the sliding plate 14, a retaining plate 32 connecting to the supporting plate 21 and a bearing base 33 provided on the retaining plate 32. The bearing base 33 accommodates the ball shaft 31. In the present embodiment, the rotating structure 30 further includes a collar 34 which is sleeved over the ball shaft 31 and screwed on the bearing base 33.

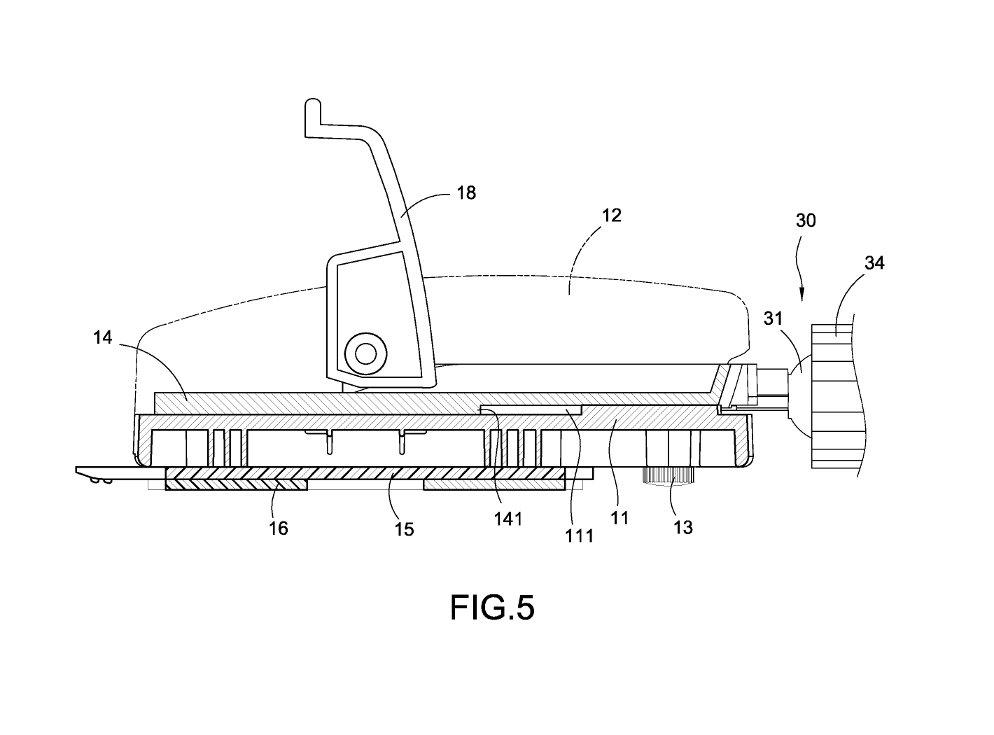

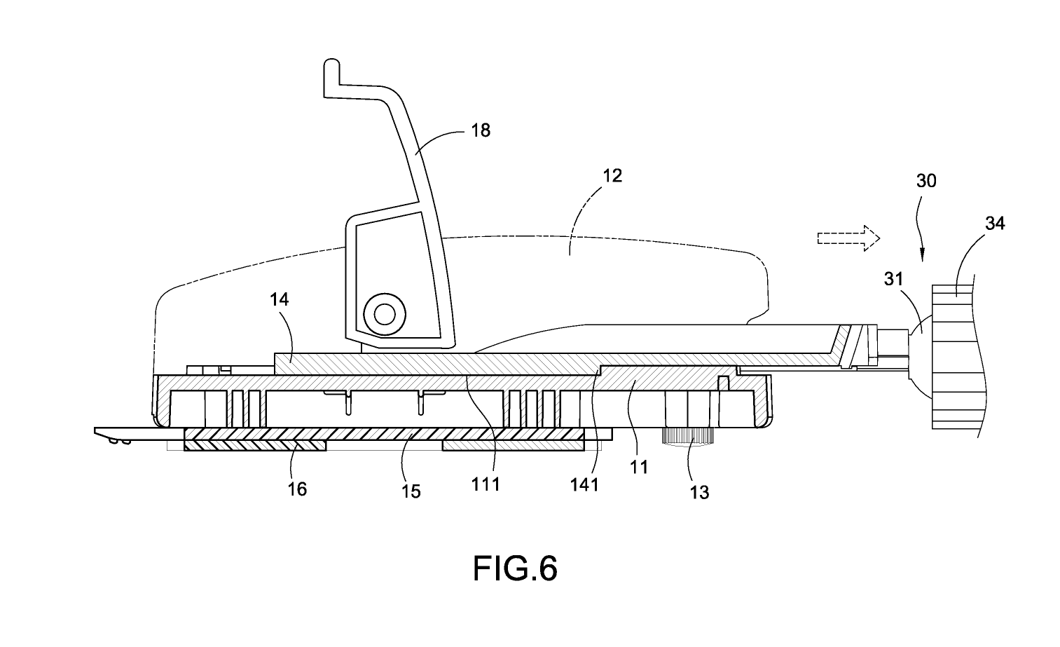

Please refer to FIGS. 5 and 6. After the fixation base 10 is assembled with the rotating structure 30 according to the present application, the sliding rail 141 of the sliding plate 14 can slide in the sliding groove 111 of the bottom board 11, thereby adjusting the backward or forward position of the clamping base 20 relative to the fixation base 10. It is clear to see from the FIGS. 5 and 6 that the sliding position of the sliding plate 14 is restricted to the length of the sliding groove 111. When the sliding rail 141 slides to the edge of the sliding groove 111, the sliding plate 14 can no longer moving outward, thereby securing the sliding plate 14 to slide on the bottom board 11 without detaching.

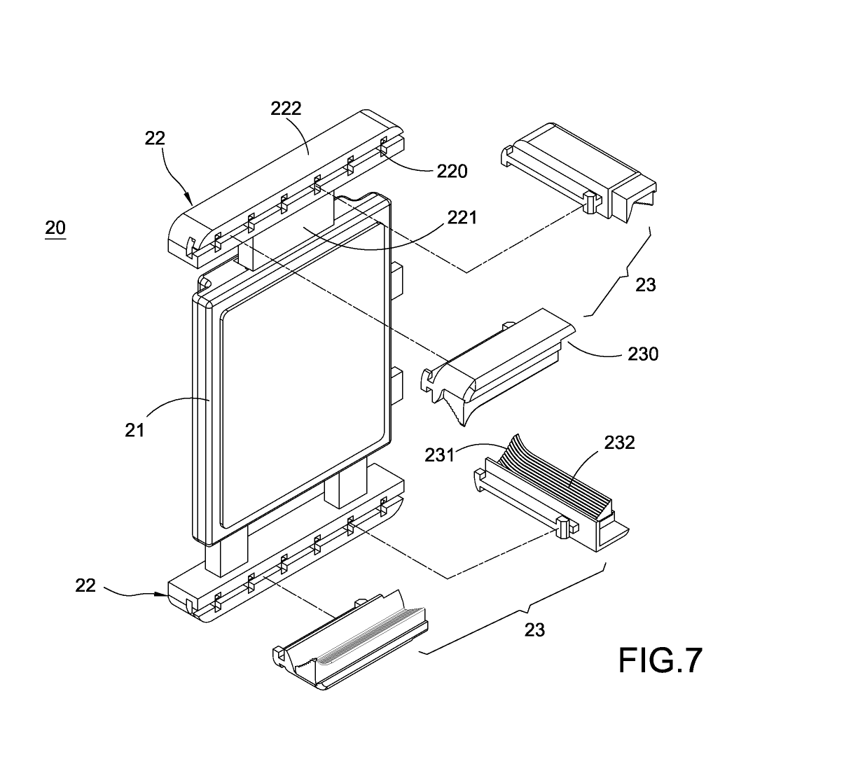

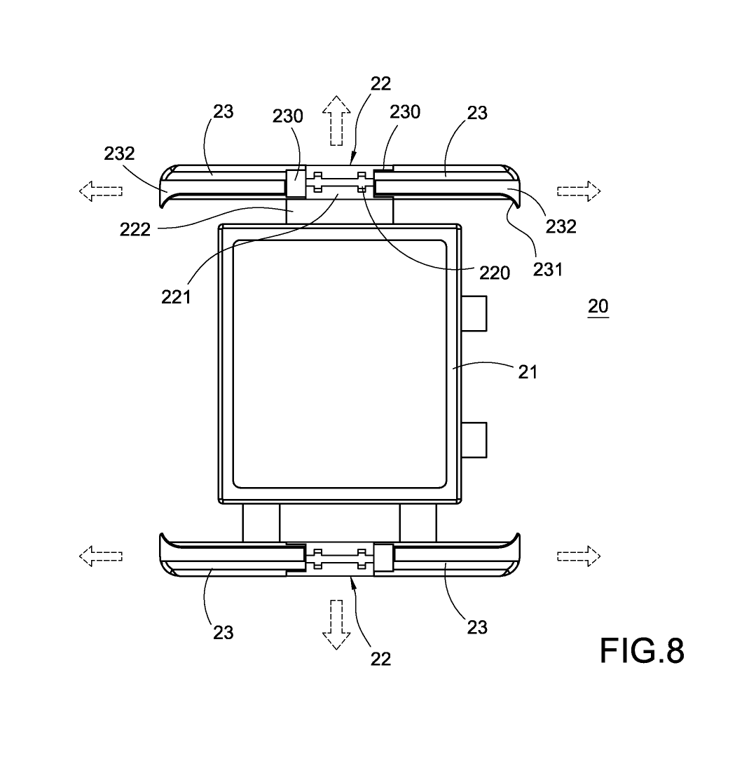

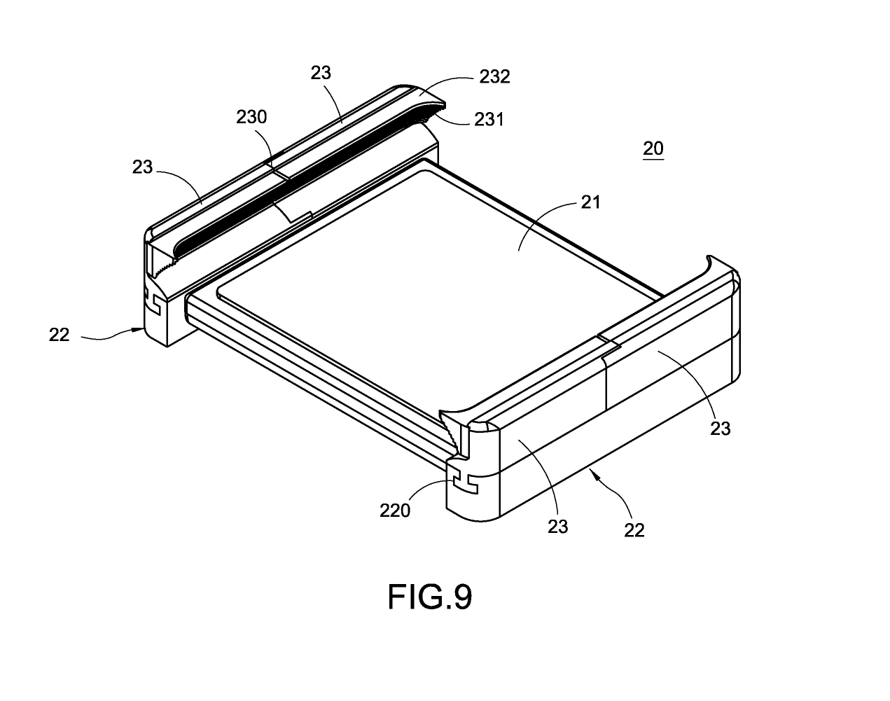

Please refer to FIGS. 7 to 9. The clamping base 20 is provided on one side of the fixation base 10 via the connecting of the rotating structure 30. The clamping base 20 includes a supporting plate 21 and two retractable plates 22 connected to two opposite sides of the supporting plate 21. The two retractable plates 22 moves in a direction parallel to the supporting plate 21, and each of the two retractable plates 22 is provided with two clamping wings 23. The two clamping wings 23 moves in a direction horizontal to the supporting plate 21. By this arrangement, the clamping base 20 can adjust the distance between two directions of the supporting plate 21 to provide the distance as user demand.

Each of the two retractable plates 22 includes a column 221 connecting inside the supporting plate 21 and a clamping element 222 connecting the column 221. The clamping element 222 is provided with a plurality of clamping grooves 220 in interval, and the two clamping wings 23 can selectively be positioned inside the clamping grooves 220. In one of the embodiment of the present application, each of the two clamping wings 23 is provided with a

L-shape groove 230 corresponding to each other, and the two L-shape grooves 230 buckles each other to make the two clamping wings 23 against each other. As such, each of the clamping wings 23 can keep the relative movement, and also be able to shorten the length of the clamping wings 23, thereby restricting the size and volume of the clamping base 20.

It is noteworthy that, in the present embodiment, an end of each of the two clamping wings 23 is formed an arc shape clamping surface 231 which is provided with a plurality of anti-slip elements 232, and the two arc shape clamping surfaces bend toward each other. By this arrangement, the clamping force of the clamping wings 23 can be improved to securely position an object clamped by the clamping wings 23.

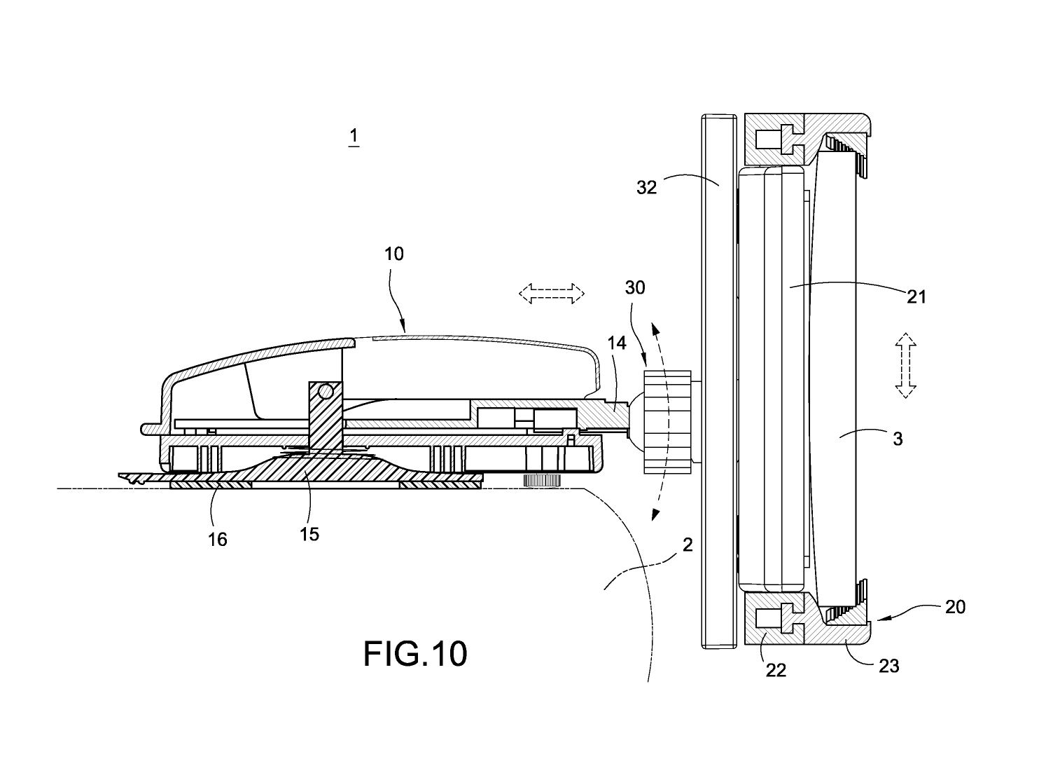

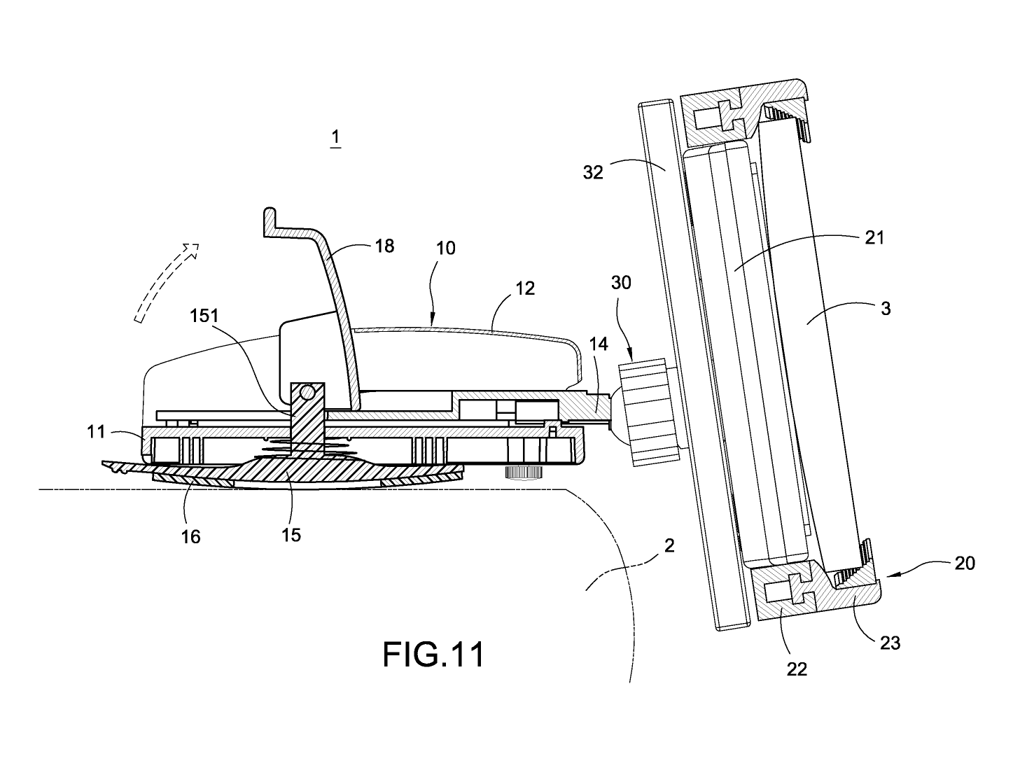

Please refer to FIGS. 10 and 11. Preferably, when using the holder 1 of the present application, the holder 1 is fixed to a dashboard 2 of the car. Besides, the portable electronic device 3 is fixed to the clamping base 20. When in practice, the fixation base 10 adheres to the dashboard 2 by using the sucking disk 15 and the rubber ring 16.

In FIG. 10, the rotating structure 30 connects the sliding plate 14 and the retaining plate 32, and the retaining plate 32 connects the supporting plate 21. Besides, when the size and shape of portable electronic devices 3 are different to each other, the clamping base 20 can adjust the retractable plate 22 and the clamping wings 23 to fittedly clamp the target portable electronic device 3. It is noteworthy that, when the sliding plate 14 moves forward or backward due to an external force, the sliding plate 14 can make the clamping base 20 move as well, which allows the user to adjust the distance between the portable electronic device 3 and the user.

As shown in FIG. 11, when the user wants to detach the holder 1 from the dashboard 2, the practice method is by lifting the pulling rod 18, and the pulling rod 18 can drive the axle 151 of the sucking disk 15 to force the sucking disk 15 to detach from the dashboard 2, thereby detaching the holder 1.

Although the present application has been described with reference to the foregoing preferred embodiments, it will be understood that the application is not limited to the details thereof. Various equivalent variations and modifications can still occur to those skilled in this art in view of the teachings of the present application. Thus, all such variations and equivalent modifications are also embraced within the scope of the application as defined in the appended claims.

What is claimed is:

1. A portable electronic device holder for car, comprising:
a fixation base comprising a bottom board and a cover covering the bottom board, a bottom of the bottom board being connected with a pair of height adjusting screw pieces, a sliding plate provided between the bottom board and the cover, a bottom of the sliding plate being provided with a sliding rail, a sliding groove being provided on the bottom board corresponding to the sliding rail, the sliding rail sliding in the sliding groove for securing the sliding plate to slide on the bottom board without detaching;
a clamping base provided on one side of the fixation base, the clamping base comprising a supporting plate and two retractable plates connected to two opposite sides of the supporting plate, the two retractable plates moving in a direction parallel to the supporting plate, each of the two retractable plates being provided with two clamping wings, the two clamping wings moving in a direction horizontal to the supporting plate; and
a rotating structure provided between the fixation base and the clamping base and connecting to the sliding plate and the supporting plate, the clamping base rotating relative to the fixation base via the rotating structure.

2. The holder according to claim 1, wherein the fixation base further comprises a sucking disk and a rubber ring, the sucking disk connects to the bottom of the bottom board, and the rubber ring adheres to a bottom of the sucking disk.

3. The holder according to claim 2, wherein the fixation base further comprises a pulling rod and a bolt, one side of the sucking disk facing to the bottom board is provided with an axle, and the pulling rod connects to the axle via the bolt to pivotally connect to the fixation base.

4. The holder according to claim 3, wherein the cover is provided with an accommodating trough corresponding to a position of the pulling rod, and the pulling rod is connected in the accommodating trough.

5. The holder according to claim 3, wherein the bottom board is provided with a through hole corresponding to a position of the axle, and the axle passes through the through hole and the sliding plate to connect the bolt.

6. The holder according to claim 2, wherein the fixation base further comprises a spring, and the spring is elastically sandwiched between the bottom board and the sucking disk.

7. The holder according to claim 1, wherein each of the two retractable plates comprises a column connecting inside the supporting plate and a clamping element connecting the column, the clamping element is provided with a plurality of clamping grooves in interval, and the two clamping wings can selectively be positioned on the clamping grooves, respectively.

8. The holder according to claim 1, wherein each of the two clamping wings is provided with a L-shape groove corresponding to each other, and two L-shape grooves buckles each other to make the two clamping wings against each other.

9. The holder according to claim 1, wherein an end of each of the two clamping wings is formed an arc shape clamping surface, and two arc shape clamping surfaces bend toward each other.

10. The holder according to claim 9, wherein the arc shape clamping surface is provided with a plurality of anti-slip elements.

11. The holder according to claim 1, wherein the rotating structure comprises a ball shaft connecting to one end of the sliding plate, a retaining plate connecting to the supporting plate, and a bearing base provided on the retaining plate; the bearing base accommodates the ball shaft.

12. The holder according to claim 11, wherein the rotating structure further comprises a collar, and the collar is sleeved over the ball shaft and screwed on the bearing base.
